(19) United States
(12) Patent Application Publication
(10) Pub. No.: US 2024/0339790 A1
(43) Pub. Date: Oct. 10, 2024

(54) TRACTION BATTERY PACK ELECTRICAL CONNECTOR

(71) Applicant: Ford Global Technologies, LLC, Dearborn, MI (US)

(72) Inventors: Micah Smith, Detroit, MI (US); Steve Droste, Canton, MI (US)

(21) Appl. No.: 18/296,391

(22) Filed: Apr. 6, 2023

(51) Int. Cl. H01R 13/74; H01R 13/652

(52) U.S. Cl. CPC H01R 13/743; H01R 13/652; H01R 2201/26

(57) ABSTRACT

A battery pack electrical connector assembly includes an outer connector having a collar that bonds to an enclosure. The outer connector includes one or more outer connector apertures, and an inner connector configured to transition back-and-forth between an engaged position and a disengaged position with the outer connector. The inner connector is received within one of the outer connector apertures when in the engaged position.

### TECHNICAL FIELD

This disclosure relates generally to and electrical connector for a traction battery pack and, more particularly, an electrical connector that can be installed without threaded fasteners.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A battery pack can power the electric machines. The battery pack of an electrified vehicle can include groups of battery cells.

### SUMMARY

In some aspects, the techniques described herein relate to a battery pack electrical connector assembly, including: an outer connector having a collar that bonds to an enclosure, the outer connector including one or more outer connector apertures; and an inner connector configured to transition back-and-forth between an engaged position and a disengaged position with the outer connector, the inner connector received within one of the outer connector apertures when in the engaged position.

In some aspects, the techniques described herein relate to an assembly, further including a header and a base of the outer connector, the header connector removably engageable with a base, the inner connector engaged with the header when in the engaged position, the base including the collar.

In some aspects, the techniques described herein relate to an assembly, further including at least one spring clip that snap-fits the header to the base when the header is engaged with the base.

In some aspects, the techniques described herein relate to an assembly, further including a seal extending circumferentially about the header, the seal sealing an interface between the header and the base when the header is engaged with the base.

In some aspects, the techniques described herein relate to an assembly, wherein the base includes at least one grounding opening, each grounding opening receiving at least one enclosure tab of the enclosure, at least the inner connector grounded to the enclosure through the at least one enclosure tab when the inner connector is in the engaged position.

In some aspects, the techniques described herein relate to an assembly, wherein the inner connector includes at least one grounding tab that contacts the at least one enclosure tab to ground the inner connector to the enclosure.

In some aspects, the techniques described herein relate to an assembly, wherein the outer connector includes at least one grounding opening, each grounding opening receiving at least one enclosure tab of the enclosure, at least the inner connector grounded to the enclosure through the at least one enclosure tab when the inner connector is in the engaged position.

In some aspects, the techniques described herein relate to an assembly, wherein the inner connector includes at least one grounding tab that contacts the at least one enclosure tab to ground the inner connector to the enclosure.

In some aspects, the techniques described herein relate to an assembly, wherein the collar is bonded to the enclosure with an adhesive that is sandwiched between the collar and the enclosure.

In some aspects, the techniques described herein relate to an assembly, wherein the collar is bonded to an exterior surface of the enclosure.

In some aspects, the techniques described herein relate to an assembly, wherein the enclosure is a metal or a metal alloy, wherein the outer connector is a polymer-based material.

In some aspects, the techniques described herein relate to an assembly, further including a plurality of wires extending from the inner connector to at least one component within the enclosure.

In some aspects, the techniques described herein relate to an assembly, wherein the inner connector is a first inner connector received within a first one of the outer connector apertures when in the engaged position, and further including a second inner connector that is configured to transition back-and-forth between an engaged position and a disengaged position with the outer connector, the second inner connector received within a second one of the outer connector apertures when in the engaged position

In some aspects, the techniques described herein relate to a method of securing an electrical connector within a battery pack, including: bonding a collar of an outer connector to an enclosure, the outer connector including at least one outer connector aperture; and engaging an inner connector within the outer connector.

In some aspects, the techniques described herein relate to a method, further including engaging the inner connector by removably coupling the inner connector to a header of the outer connector, the header removably coupled to a base of the outer connector.

In some aspects, the techniques described herein relate to a method, further including providing a seal between the base of the outer connector and the header of the outer connector.

In some aspects, the techniques described herein relate to a method, further including contacting an enclosure tab of the enclosure against a grounding tab of the inner connector to ground the inner connector to the enclosure.

In some aspects, the techniques described herein relate to a method, further including adhesively securing the collar to the enclosure to bond the collar to the enclosure.

In some aspects, the techniques described herein relate to a method, further including adhesively securing the collar to an exterior surface of the enclosure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates a perspective view of the traction battery pack from the electrified vehicle of FIG. 1.

FIG. 2A illustrates a close-up view of an area of the traction battery pack of FIG. 2 showing the electrical connector.

FIG. 3 illustrates an expanded view of the electrical connector in FIG. 2A.

FIG. 4 illustrates a section view taken at line 4-4 in FIG. 2A when the electrical connector is assembled.

FIG. 5 illustrates a section view taken at line 5-5 in FIG. 2A when the electrical connector is assembled.

### DETAILED DESCRIPTION

This disclosure details example electrical connector assemblies used in connection with a traction battery packs. The exemplary electrical connector assemblies can be installed without using threaded, mechanical fasteners. The exemplary electrical connector assemblies can use materials that are not prone to corrosion.

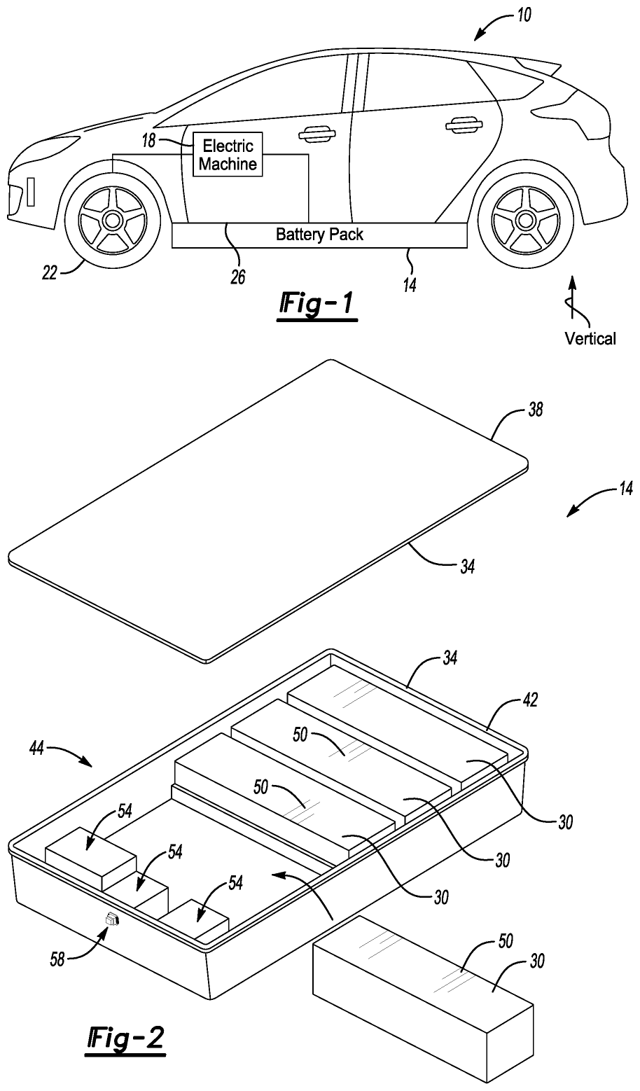

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 can be a relatively high-voltage battery.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

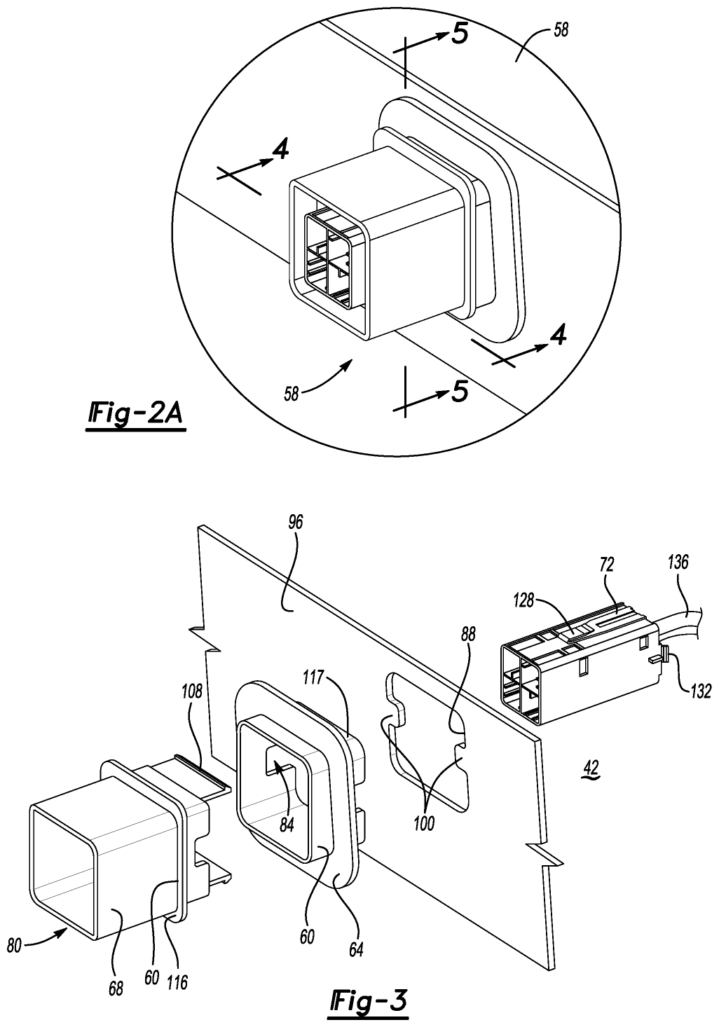

With reference now to FIGS. 2 and 2A, the battery pack 14 includes a plurality of battery arrays 30 held within an enclosure assembly 34. In the exemplary embodiment, the enclosure 34 includes an enclosure cover 38 and an enclosure tray 42. The enclosure cover 38 is secured to the enclosure tray 42 to provide an interior area 44 that houses the plurality of battery arrays 30.

The battery arrays 30 each includes a plurality of battery cells 50 (or simply, “cells”) stacked side-by side relative to each other. The battery cells 50 are for supplying electrical power to various components of the electrified vehicle 10.

Although a specific number of cells 50 and arrays 30 are illustrated in the various figures of this disclosure, the battery pack 14 could include any number of arrays 30 having any number of cells 50. In other words, this disclosure is not limited to the specific configuration shown in FIG. 2.

Other components 54 are housed within the enclosure 34. Examples of the other components 54 can include control modules. In particular, the other components housed within the enclosure 34 can include a Bussed Electrical Center (BEC), a Battery Electronic Control Module (BECM), a Protected Direct Current to Direct Current (pDCDC) converter, a Direct Current to Direct Current (DCDC) converter, and a Battery Pack Sensor Module (BPSM). The battery pack 14 includes at least one electrical connector assembly 58. The vehicle 10 can operably couple to the at least one electrical connector assembly 58 to communicate with the components of the battery pack 14, to power components of the battery pack 14, or some combination of these.

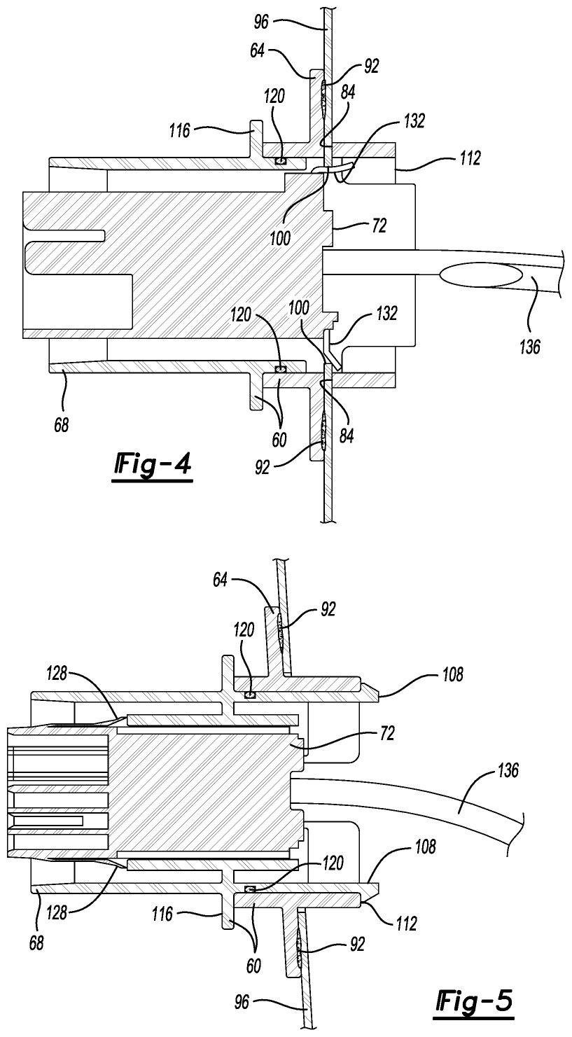

With reference now to FIG. 3-5 and continuing reference to FIGS. 2 and 2A, the example electrical connector assembly 58 includes an outer connector 60 having a base 64 and a header 68. The electrical connector assembly 58 further includes an inner connector 72. In this example, the base 64 and the header 68 are separate structures, and the header 68 is removably engageable with the base 64. In another example, the base 64 and the header 68 are different portions of a singular, outer connector structure.

The example outer connector 60 includes at least one outer connector aperture 80, and at least one grounding opening 84. When installed, the outer connector 60 fits within an aperture 88 of the enclosure 34, which, in this example, is a metal or metal alloy material. The outer connector 60, in contrast to the enclosure 34 is a polymer-based material. The aperture 88 is in the enclosure tray 42 in this example. In another example, the enclosure tray 42 is in the enclosure cover 38.

The example outer connector 60 is bonded to the enclosure 34 with adhesive. More specifically, the collar 76 of the base 64 is bonded to the enclosure 34 with an adhesive 92 that is sandwiched between the collar 76 and an exterior surface 96 of the enclosure 34. A depth stop could extend from a back of the collar 76 toward the enclosure 34 to control a gap between the collar 76 and the enclosure 34.

The enclosure 34 includes enclosure tabs 100. When the outer connector 60 is secured to the enclosure 34, the enclosure tabs 100 are each received a respective one of the grounding openings 84.

In this example, after the collar 76 of the base 64 is bonded to the enclosure 34, the header 68 is engaged with the base 64. The header 68 is removably engaged with the base 64 in this example. The header 68 clips to the base 64 with a pair of spring clips 108 in this example. The spring clips 108 engage an aft end 112 of the base 64 to clamp a portion of the base 64 between the spring clips 108 and an annular stop 116 of the header 68. The spring clips 108 snap-fit the header 68 to the base 64. The spring cops

An annular seal 120 seals an interface between the header 68 and the base 64. The annular seal 120 extends circumferentially about the header 68. The annular seal 120 can fit within a groove of the header 68. The annular seal 120 can be a press-in-place or co-molded seal. The annular seal 120 can block movement of contaminants and moisture between the interior arca 44 of the battery pack 14 and areas outside the enclosure 34. Similarly, the adhesive 92 can provide a seal that blocks movement of contaminants and moisture between the collar 76 and the exterior surface 66.

The outer connector aperture 80 receives the inner connector 72 when the inner connector 72 is in the engaged position. The inner connector 72 is configured to transition back-and-forth between the engaged position and a disengaged position with the outer connector 60.

The inner connector 72 removably engages the outer connector 60 via engagement tabs 128 in this example.

The inner connector 72 includes at least one grounding tab 132. The enclosure tabs 100 extending through the grounding openings 84 in the outer connector 60 can contact the at least one grounding tab 132 to ground the inner connector 72 to the enclosure 34 when the inner connector 72 is engaged with the outer connector 60.

The inner connector 72 is coupled to a plurality of wires 136 in this example. The wires 136 each extend from the inner connector 72 to at least one component within the enclosure 34, such as the components 54.

The example outer connector 60 includes one outer connector aperture 80 that receives the inner connector 72. In another examples, the outer connector 60 could include more than one outer connector aperture 80 each receiving an inner connector 72. For example, the outer connector 60 could include a first outer connector aperture that receives a first inner connector, and a second outer connector aperture that receives a second outer connector.

Features of some of the disclosed examples include a connector that can primarily utilize polymer-based components, which can help to reduce potential corrosion issues. The connector can have a compressed, sealed interface without necessarily relying on mechanical fasteners, such as bolts, to apply the compressive force. The connector can be used in different types of traction battery packs to reduce complexity across programs. The connector's components can provide common integrated features to assist with an automated grapping and installing of the connector during installation.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack electrical connector assembly, comprising:
an outer connector having a collar that bonds to an enclosure, the outer connector including one or more outer connector apertures; and
an inner connector configured to transition back-and-forth between an engaged position and a disengaged position with the outer connector, the inner connector received within one of the outer connector apertures when in the engaged position.

2. The assembly of claim 1, further comprising a header and a base of the outer connector, the header connector removably engageable with a base, the inner connector engaged with the header when in the engaged position, the base including the collar.

3. The assembly of claim 2, further comprising at least one spring clip that snap-fits the header to the base when the header is engaged with the base.

4. The assembly of claim 2, further comprising a seal extending circumferentially about the header, the seal sealing an interface between the header and the base when the header is engaged with the base.

5. The assembly of claim 2, wherein the base includes at least one grounding opening, each grounding opening receiving at least one enclosure tab of the enclosure, at least the inner connector grounded to the enclosure through the at least one enclosure tab when the inner connector is in the engaged position.

6. The assembly of claim 5, wherein the inner connector includes at least one grounding tab that contacts the at least one enclosure tab to ground the inner connector to the enclosure.

7. The assembly of claim 1, wherein the outer connector includes at least one grounding opening, each grounding opening receiving at least one enclosure tab of the enclosure, at least the inner connector grounded to the enclosure through the at least one enclosure tab when the inner connector is in the engaged position.

8. The assembly of claim 7, wherein the inner connector includes at least one grounding tab that contacts the at least one enclosure tab to ground the inner connector to the enclosure.

9. The assembly of claim 1, wherein the collar is bonded to the enclosure with an adhesive that is sandwiched between the collar and the enclosure.

10. The assembly of claim 9, wherein the collar is bonded to an exterior surface of the enclosure.

11. The assembly of claim 1, wherein the enclosure is a metal or a metal alloy, wherein the outer connector is a polymer-based material.

12. The assembly of claim 1, further comprising a plurality of wires extending from the inner connector to at least one component within the enclosure.

13. The assembly of claim 1, wherein the inner connector is a first inner connector received within a first one of the outer connector apertures when in the engaged position, and further comprising a second inner connector that is configured to transition back-and-forth between an engaged position and a disengaged position with the outer connector, the second inner connector received within a second one of the outer connector apertures when in the engaged position.

14. A method of securing an electrical connector within a battery pack, comprising:
bonding a collar of an outer connector to an enclosure, the outer connector including at least one outer connector aperture; and
engaging an inner connector within the outer connector.

15. The method of claim 14, further comprising engaging the inner connector by removably coupling the inner connector to a header of the outer connector, the header removably coupled to a base of the outer connector.

16. The method of claim 15, further comprising providing a seal between the base of the outer connector and the header of the outer connector.

17. The method of claim 14, further comprising contacting an enclosure tab of the enclosure against a grounding tab of the inner connector to ground the inner connector to the enclosure.

18. The method of claim 14, further comprising adhesively securing the collar to the enclosure to bond the collar to the enclosure.

19. The method of claim 18, further comprising adhesively securing the collar to an exterior surface of the enclosure.
